(19) United States
(12) Patent Application Publication
(10) Pub. No.: US 2019/0318583 A1
(43) Pub. Date: Oct. 17, 2019

(54) CARDPLAY CASINO GAMES SYSTEMS AND METHODS

(71) Applicant: Peter Thanh Khai, North Hills, CA (US)

(72) Inventor: Peter Thanh Khai, North Hills, CA (US)

(21) Appl. No.: 15/953,451

(22) Filed: Apr. 15, 2018

(51) Int. Cl. G07F 17/32

(52) U.S. Cl. CPC G07F 17/3293; G07F 17/3227; G07F 17/3211

(57) ABSTRACT

A cardplay casino games system which enables a card-based video simulation of casino gameplay and which provides visual aids for the card game play of casino table games. The system includes cards for play of the game, a dealer's station, and players' mobile devices, connectable through a network to the dealer station, for enabling the placement of wagers and display of the casino game process. The cards include readable data. The system further includes a dealer's display monitor for providing a display of visual aids, an input device for reading and translating the data from the cards into correlated and configured casino games outcomes, and a processing system to enable different game configurations for simulations of cardplay casino games. The cardplay casino game is played by the dealer, and the results are broadcast from the dealer's station to players' mobile devices through the processing system and the network.

### CROSS-REFERENCE TO RELATED APPLICATION

This application is claiming the benefit of co-pending utility application Ser. No. 15/095,150 filed on Apr. 10, 2016.

### COPYRIGHTABLE SUBJECT MATTER

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

### 1. Field of the Invention

This invention is generally related to casino games, and more particularly, to systems and methods for playing casino games with cards for the play of the game.

### 2. General Background and State of the Art

Casino games are games of chance which are generally played offline, in a casino in a building such as a hotel, or online, in online casinos.

In a casino game, the players gamble casino chips on various possible random outcomes or combinations of outcomes in the play of the game.

Casino games include table games and electronic gaming machines. Table games require the involvement of casino employees to play, while electronic gaming machines, such as slot machines and pachinko, are usually played by one player at a time and do not require the involvement of casino employees to play.

Casino games which are played offline or online include games such as Roulette, Craps, and Sicbo.

Roulette is a casino table game of chance, which is played at a Roulette table. In the game, players may choose to place bets on either a single number or a range of numbers, the colors red or black, or whether the number is odd or even. The casino employee spins a wheel in one direction, then spins a ball in the opposite direction around a tilted circular track running around the circumference of the wheel. The ball eventually loses momentum and falls onto the wheel and into one of a number of colored and numbered pockets on the wheel.

Craps is another casino table game of chance, which is played with dice, in which the players make wagers on the outcome of the roll, or a series of rolls, of a pair of dice. Players may wager money against a bank.

Sicbo is a further casino table game of chance, which is played with three dice. It is of ancient Chinese origin, and is currently widely played in Asia and in many other countries. Gameplay involves betting that a certain condition will be the result of a roll of the dice, for example that all three dice will roll the same,

There is a need to provide systems and methods for the play of casino games, including Roulette, Craps, and Sicbo, through a dealer and players on mobile devices, connected through a network to a dealer location for the play of the game, wherein the game is played by the use of cards, and transmitted over the network between the dealer and the mobile devices players.

### INVENTION SUMMARY

Briefly, and in general terms, in accordance with aspects of the invention, and in preferred embodiments, by way of example, there are provided systems and methods for the automation of the card game process which provides visual aids for the card game play of casino table games. The games which are played on the system comprise simulations of casino games, with the same or similar rules, odds and payouts, and include cards for the play of the games.

In accordance with other aspects of the invention, the cardplay casino game systems and methods include the gameplay pieces, for example, cards for the play of the game, such as cards, standard playing cards, pull tabs, or paper.

In accordance with further aspects of the invention, the system enables the casino games to be played without the physical equipment of the casino games, such as a wheel, a ball, and dice, to enable play of the game with cards.

In accordance with other aspects of the invention, the cardplay casino game systems and methods include a processing system, which includes a processor and memory, and software able to be implemented in the processing system. The software is further able to be implemented to enable a configuration menu for different game configurations, for simulations of cardplay casino games.

Also, In accordance with aspects of the invention, the cardplay casino game systems and methods include a game dealer, and game players on mobile devices connected through a network to the game dealer game for enabling and displaying the placement of wagers on the game results, the playing of the game, and for providing the results of the game.

In accordance with other aspects of the invention, the cardplay casino game systems and methods include a dealer station game table, the layout design of which is set up to match the game rules.

Further, in accordance with aspects of the invention, the cards of the cardplay casino game systems and methods include imprinted media such as barcodes or other types of readable media, and the system includes an input reading device and a visual aid display for reading the imprinted media data in the readable media in the cards and translating of data into the visual aid display device.

In another aspect of the invention, the system includes dealer and players display devices, connected through a network, where the visual aid device results are displayed to the dealer and the players over the network.

Also, in accordance with aspects of the invention, the system further includes random number generation, comprising game piece shuffling, implemented manually, mechanically, or by computer.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a perspective view of a dealer station in an embodiment of the cardplay casino game system and method of the present invention;

FIG. 2 is an elevational view of game pieces in an embodiment of the cardplay casino game system and method of the present invention;

FIG. 3 is a perspective view of a game table in an embodiment of the cardplay casino game system and method of the present invention;

FIG. 4 is a diagrammatical view of a game dealer and game players and a game in an embodiment of the cardplay casino game system and method of the present invention;

FIG. 5 is a perspective view of mobile devices in in an embodiment of the cardplay casino game system and method of the present invention;

FIG. 6 is a diagram of a network in an embodiment of the cardplay casino game system and method of the present invention;

FIG. 7 is an elevational view of cards and readable media in an embodiment of the cardplay casino game system and method of the present invention;

FIG. 8 is a perspective view of a processing system in an embodiment of the cardplay casino game system and method of the present invention;

FIG. 9 is a perspective view of a processing device and software in an embodiment of the cardplay casino game system and method of the present invention;

FIG. 10 is a screen shot view of an instructions screen in an embodiment of the cardplay casino game system and method of the present invention;

FIG. 11 is a perspective view of a configuration menu in an embodiment of the cardplay casino game system and method of the present invention;

FIG. 12 is a screen shot view of a lookup tables screen in an embodiment of the cardplay casino game system and method of the present invention;

FIG. 13 is a perspective view of a display in an embodiment of the cardplay casino game system and method of the present invention;

FIG. 14 is a screen shot view of a side bets screen in an embodiment of the cardplay casino game system and method of the present invention;

FIG. 15 is a screen shot view of a jackpots screen in an embodiment of the cardplay casino game system and method of the present invention

FIG. 16 is perspective view of a game piece shuffling device in an embodiment of the cardplay casino game system and method of the present invention;

FIG. 17 is perspective view of a random number generator device in an embodiment of the cardplay casino game system and method of the present invention;

FIG. 18 is perspective view of a readable media recognition device in an embodiment of the cardplay casino game system and method of the present invention;

FIG. 19 is screen shot view of mapping table screens in an embodiment of the cardplay casino game system and method of the present invention;

FIG. 20 is an elevational view of an input reading device in an embodiment of the cardplay casino game system and method of the present invention;

FIG. 21 is a perspective view of an input device in an embodiment of the cardplay casino game system and method of the present invention;

FIG. 22 is a perspective view of a visual aid device, a dealer display device, and a player display device in an embodiment of the cardplay casino game system and method of the present invention;

FIG. 23 is a perspective view of a touch screen device and a graphical display device in an embodiment of the cardplay casino game system and method of the present invention;

FIG. 24 is diagrammatical view of a dealer station table in an embodiment of the cardplay casino game system and method of the present invention;

FIG. 25 is perspective view of a game piece shuffling device in an embodiment of the cardplay casino game system and method of the present invention;

### DETAILED DESCRIPTION OF THE PREFERRED EMBODIMENTS

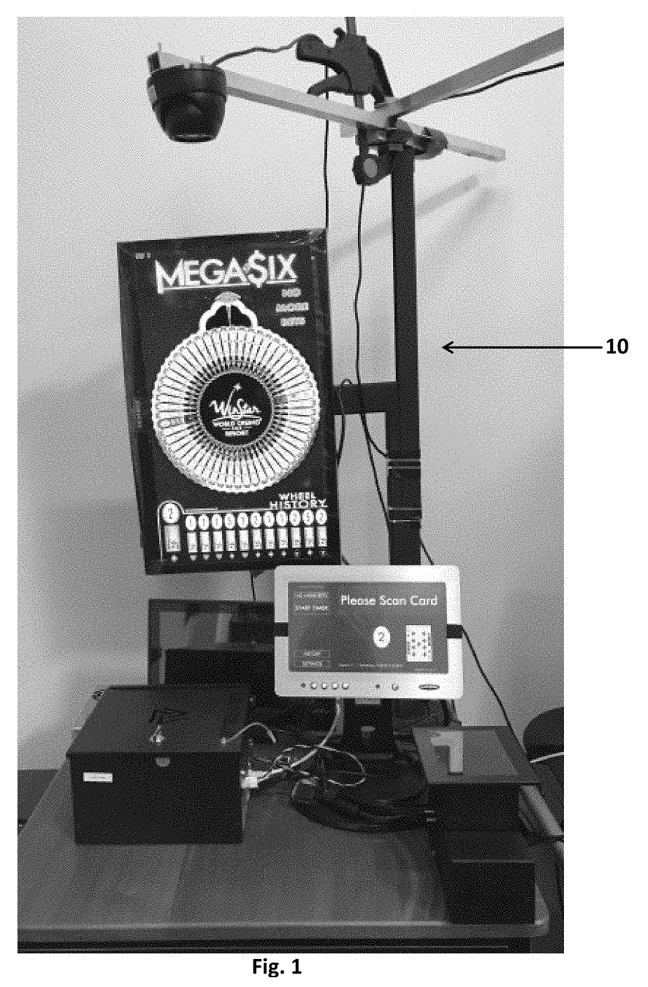

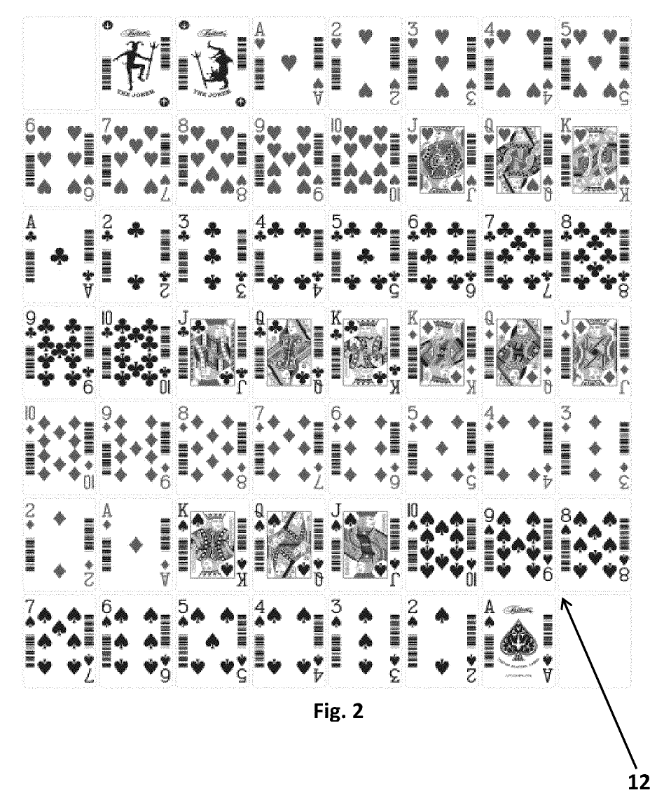

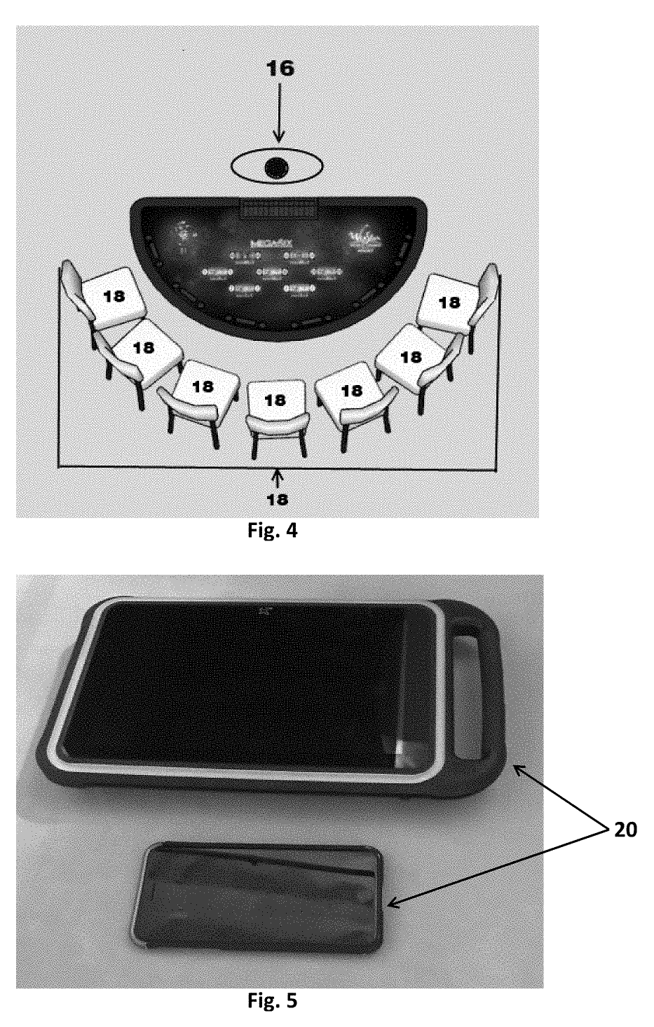

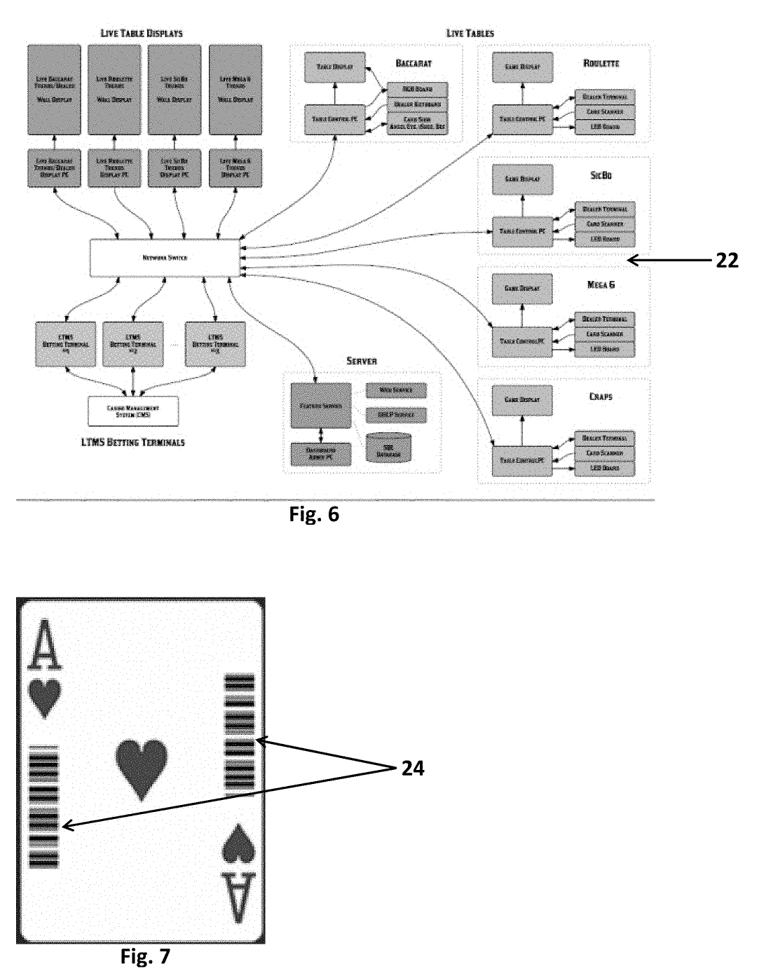

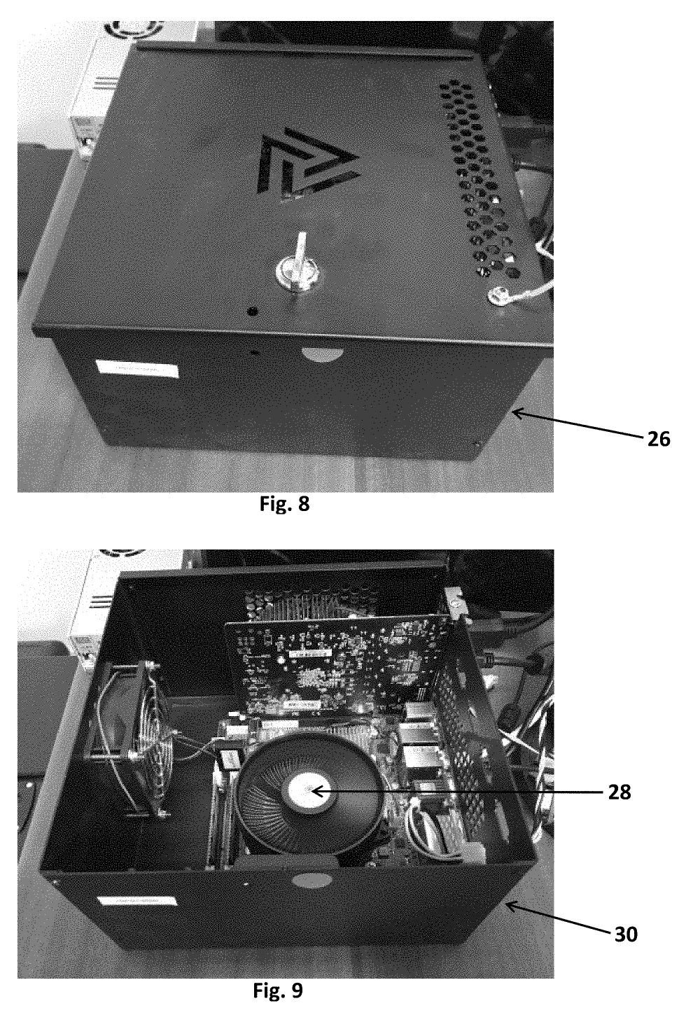

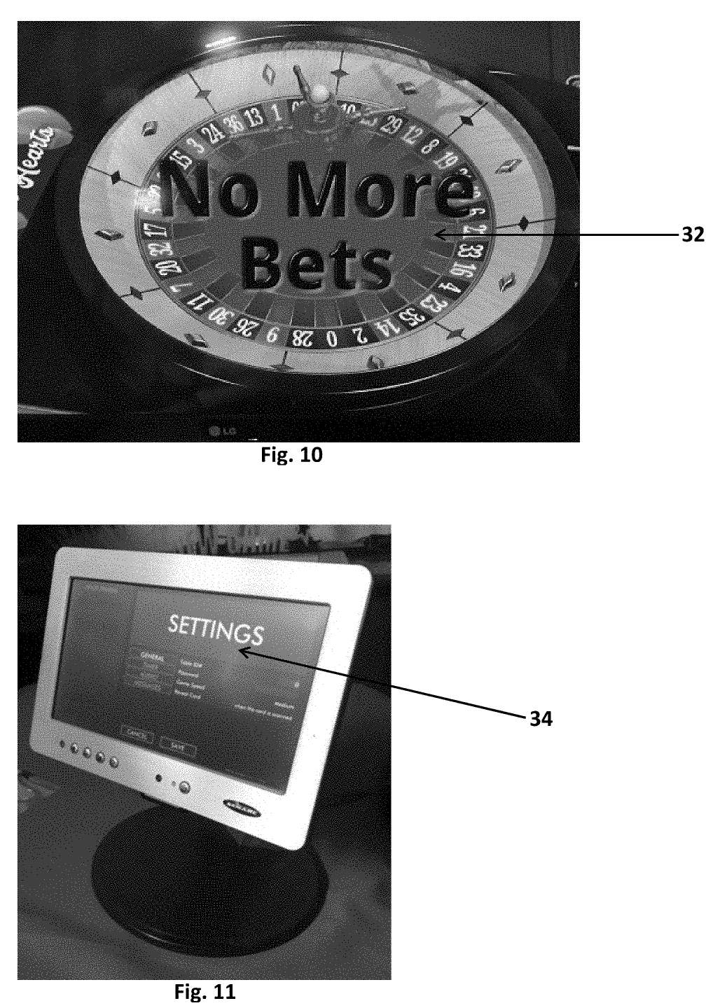

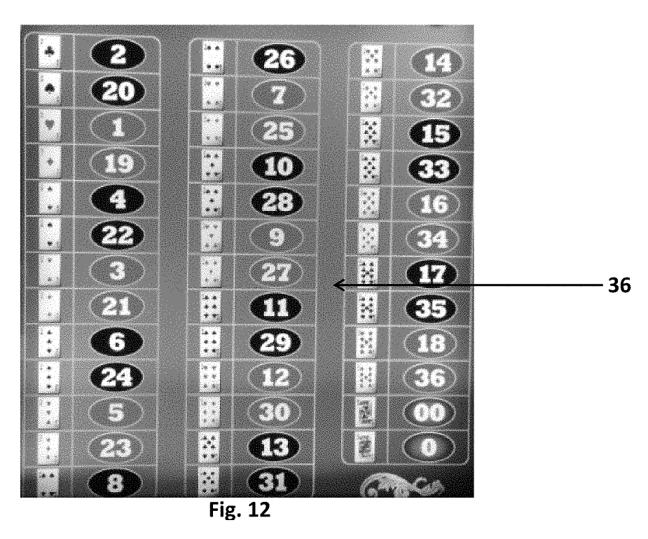

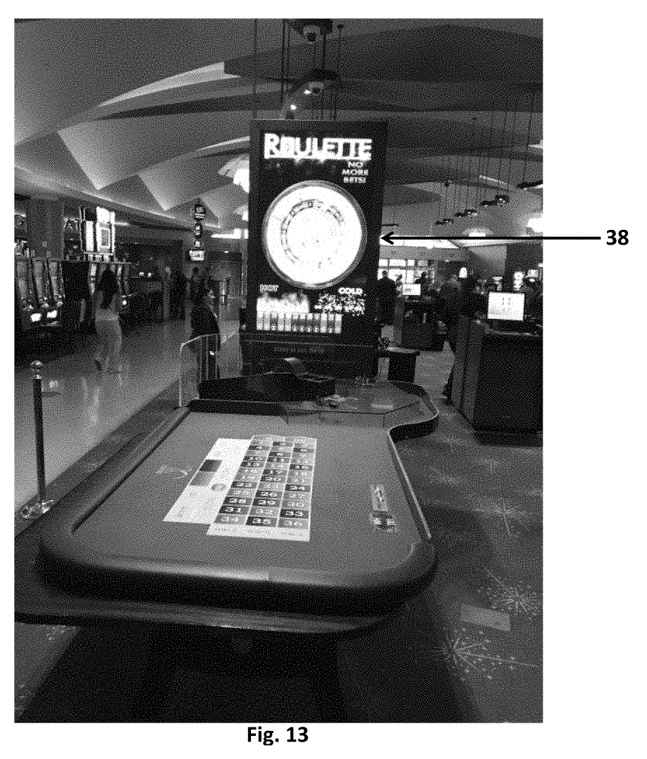

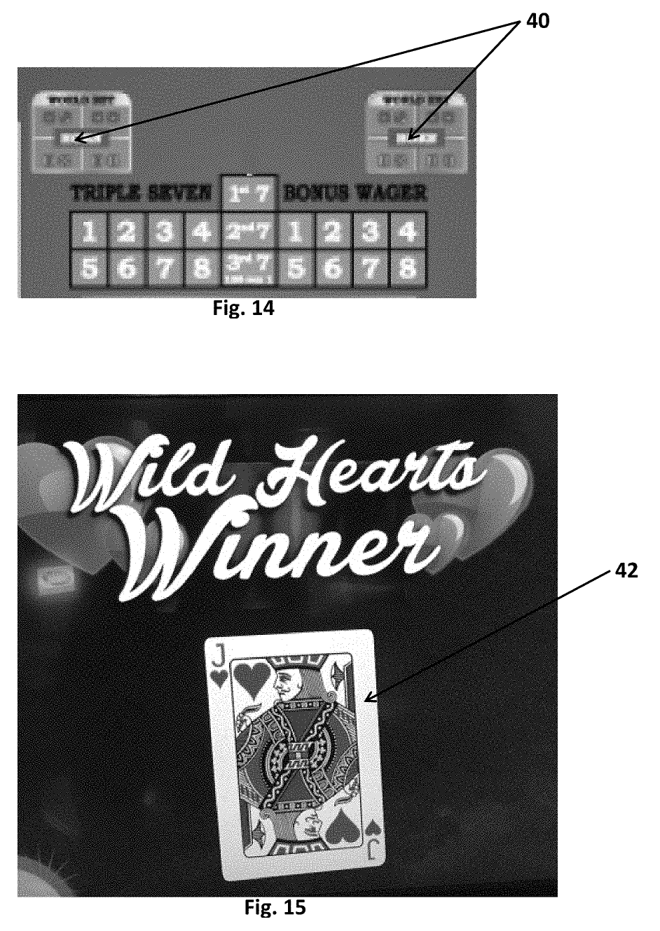

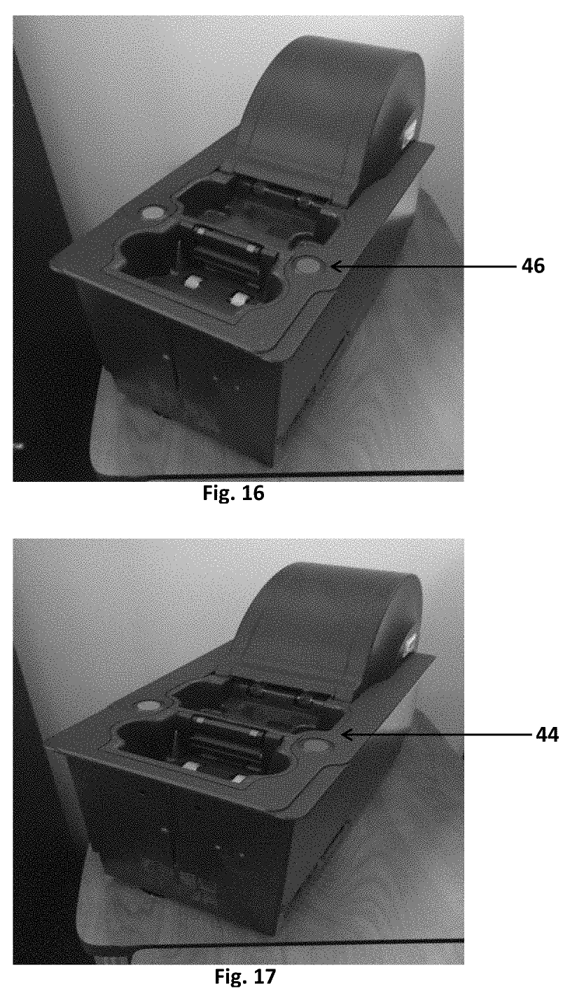

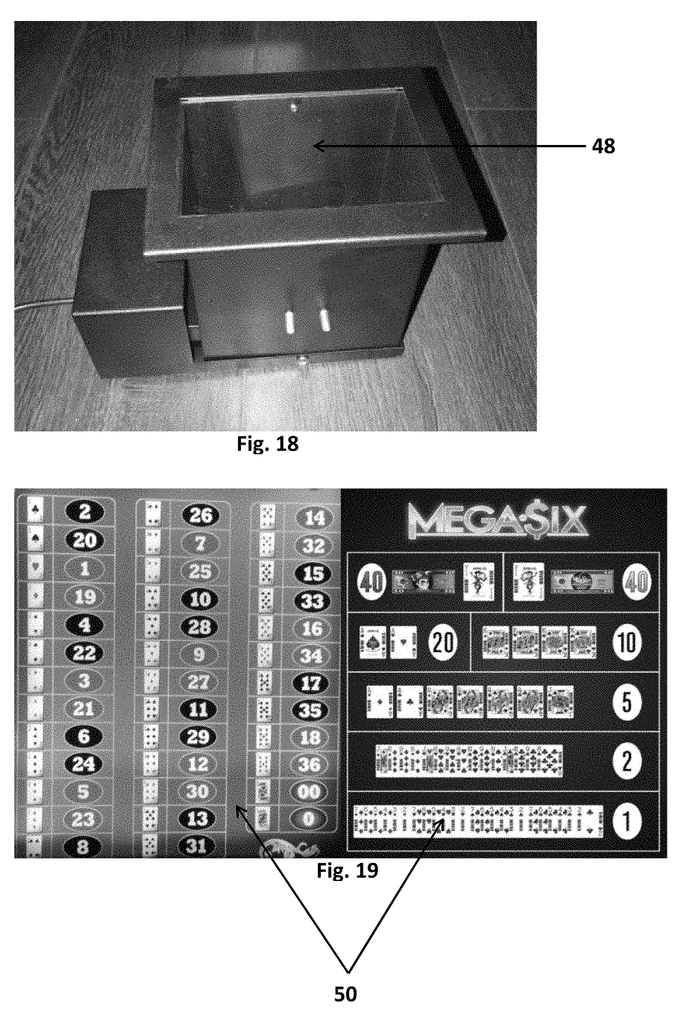

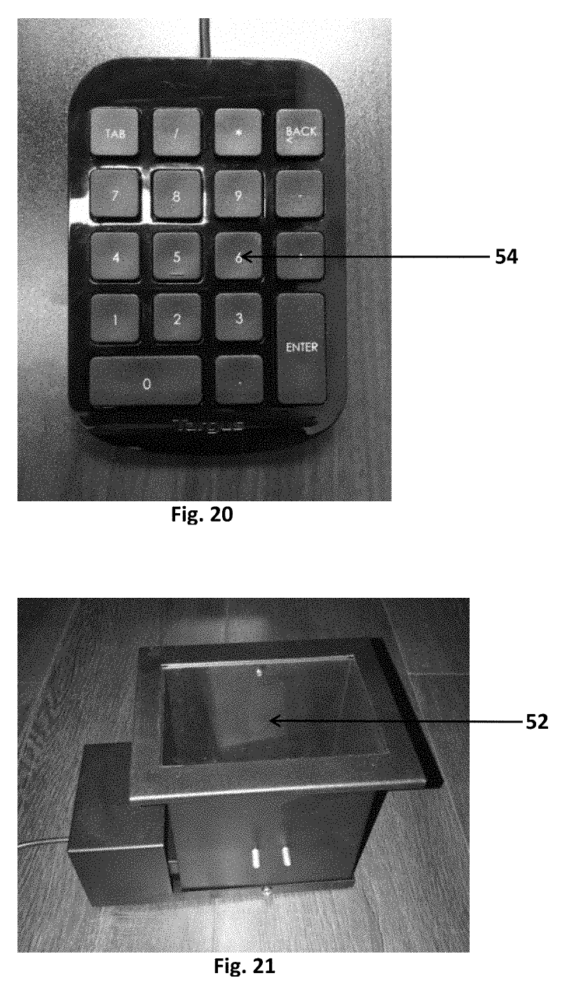

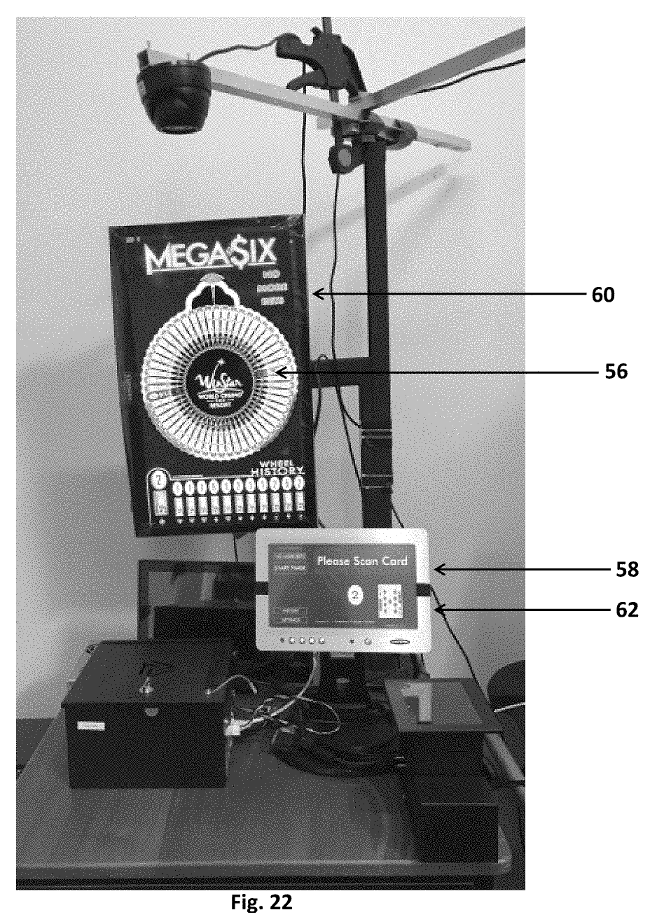

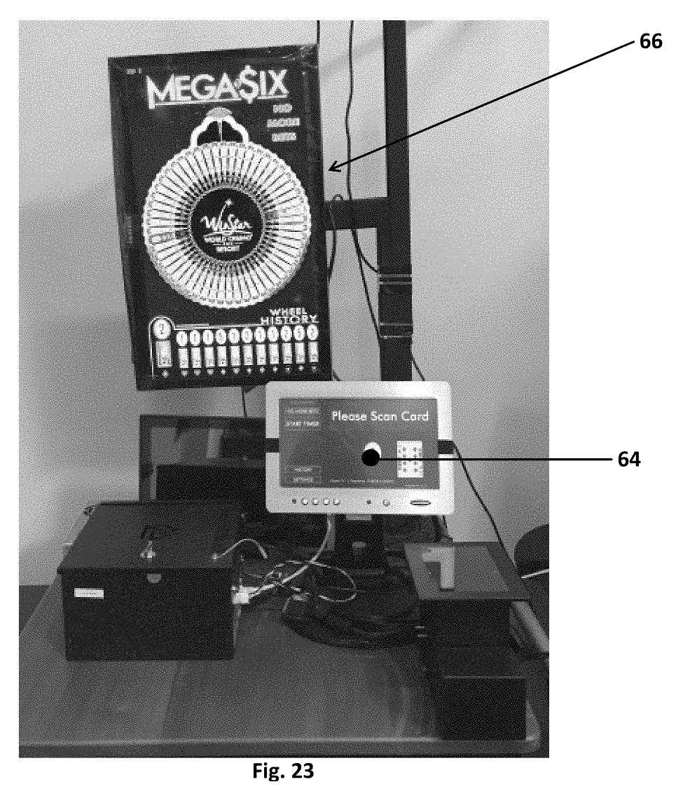

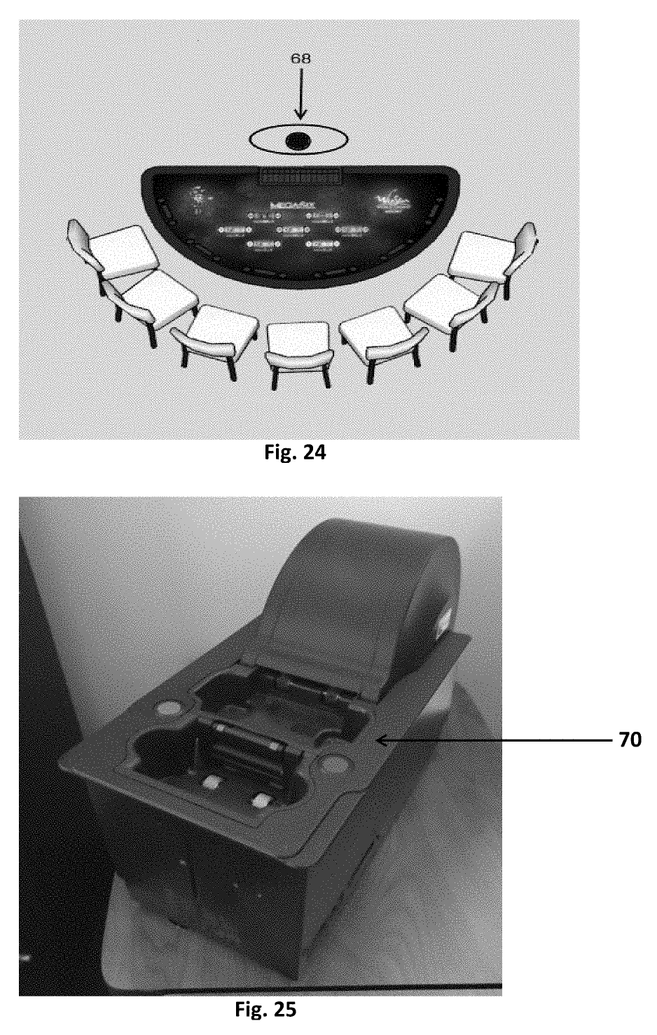

Referring to the drawings, FIGS. 1-25, the system 10, in the preferred embodiments, is able to automate a game playing process and provides visual aids for the game. It includes cardplay casino games which include cards for the play of the game, and which comprise simulations of casino games. The simulations of casino games are played with the same or similar rules, odds and payouts. There are first and second games which are played on the system 10. The first game is a cardplay game and the second game is a visual aid game which includes a casino game. A third game is also able to be played on the system, derived from the play of the first game into the play of the second game and then into the play of the third game. The third game is a visual aid game which includes a side bet game or a jackpot game.

The system also includes a game table 14, the layout design of which is set up to match the game rules. There is a game dealer 16, and game players 18 on mobile devices 20 connected through a network 22 to the game dealer game for enabling the placement of wagers on the game results.

The cardplay casino cards game pieces 12 which are used in the system 10 for the play of the game comprise sets of cards such as standard playing cards, pull tabs or printed paper. The cards include readable media 24 such as barcodes, scannable media, or radio frequency identification applied to the cards. The system enables the casino games to be played without the physical equipment of the casino games, such as a wheel, a ball, and dice, to enable play of the game with cards.

The system further includes a processing system 26, which includes a processing device 28, such as a central processing unit and memory, able to be programmed to automatically carry out set operations. The system also includes software 30, able to be implemented in the processing system 26, which includes a set of instructions 32 which directs the processing system to perform specific tasks or operations. The software is further able to be implemented so as to enable a configuration menu 34 for different game configurations, for simulations of cardplay casino games such as roulette, craps, and sicbo.

The software is also able to be implemented to enable look up tables 36, and to enable the reading in of data and the comparing of data to the look up tables for the play of the game. The software is further able to be implemented to enable graphics and sound to displays 38. Further, The software is able to be implemented to maintain a history of game results for auditing and security of card events.

The software is further able to be implemented for enabling side bets 40 and jackpots 42 in the play of the game. Side bets are added to the original games, such as triple sevens bonus on craps game. The side bet of triple seven bonus wager for example would be available to all players wagering on the Pass or Don't Pass lines, and relies on the occurrence of three consecutive sevens being rolled, beginning on the come out roll. The wager will pay 125 to 1 on the third consecutive seven.

The system includes a randomness, implemented by card shuffling, which is performed by computer for a random number generation device 44, comprising a game piece shuffling device 46 such as shuffling of the cards. The cards for the play of the game are also used to determine the game's random number generation. The cards are thoroughly shuffled, either by the dealer, with an automatic card shuffler or by hand, or by a machine or computer without the dealer. Each playing card includes unique readable media implemented thereon for distinguishing each card and keeping it apart in computerized or virtual use through a readable media recognition device 48. The unique readable media may comprise a bar code, which may be read by a bar code reader, or may comprise other media which may be read by a recognition video camera or by radio frequency identification.

The game is played and operated by the dealer, and the results are broadcast to players' mobile devices, from which players are able to play the game. The game results from the manual game are sent to mobile devices that are connected to the network 22. The players playing in the same game on their mobile devices as the live dealer game is being played.

The readable media, such as barcodes, camera recognition, scannable media, or radio frequency identification, on the cards in the system, are readable through reading devices 48 included in the system for reading the readable media, such as a barcode reader, a scanner, or recognition camera devices, and for translating of the data being read. The reading and translating of the readable media enables the play of the game.

The system 10 further includes a mapping table 50 and an input device 52. The data on the cards is correlated to the mapping table 50. The mapping table 50 is programmed to read the values from the input device 52. The system further includes an input reading device 54, for reading the game pieces to scan data for the play the game. The input reading device comprises a device such as a recognition scanner, a recognition barcode reader, a recognition video camera, or a recognition digital camera. The input reading device reads the data and translates the data for display in the visual aid display, which may include a visually-aided graphical display.

The system still further includes a visual aid display device 56. The values from the input device 52 are checked against the programmed mapping table 50, and visual aid display device results are obtained. The system enables automating of the card game, with the reading of data including the translating of data into the visual aid display device 56. The data for the play of the game is implemented on any material, is of any shape or size, and is, for example, barcode or graphics. The data is correlated to the programmed mapping table 50 and a visual aid game display 56 to a game dealer and game players display is formed.

Further, the system includes a dealer display device 58 and players display devices 60, connected through a network 22 which includes a networking device such as a router, which forwards data packets between computer networks. The visual aid device game play process and game results are displayed to the dealer and the players over the network 22. The displays 38 include displays such as liquid crystal displays, mobile smart phone displays, and chart board displays which display images of the cardplay casino game. The displays 38 enabled by the system include a dealer monitor 62 with a touch screen display 64, and visual aid displays for displaying the game to players and a graphical display 66 for enabling signage. The system enables the play of the game, with the results transmitted to the player mobile phone devices connected to the network, so that players are able to play from the player mobile phone devices. The system enables the players to play in the same game as the live dealer game being played.

In operation as seen in Figs, 1-25, the system enables a cardplay casino game to be played in manual or automated mode. The game is played by the dealer manually, with the dealer at the dealer station table 14, for example for a cardplay casino game of roulette, or for a cardplay casino game of craps. and the results are broadcast to players' mobile devices 20, from which players are able to play the game. The game results from the manual game are sent to mobile devices 20 that are connected to the network 22.

The players are playing in the same game on their mobile devices as the live manual dealer game is being played. Casino games are enabled to be modified by the system to include side bets or jackpots. Mobile player devices are enabled to connect through the network 22 to the manual game, enabling the placement of wagers on the same manual game results as generated at the live dealer game. The system further includes randomness, comprising game piece shuffling, implemented manually, mechanically, or by computer.

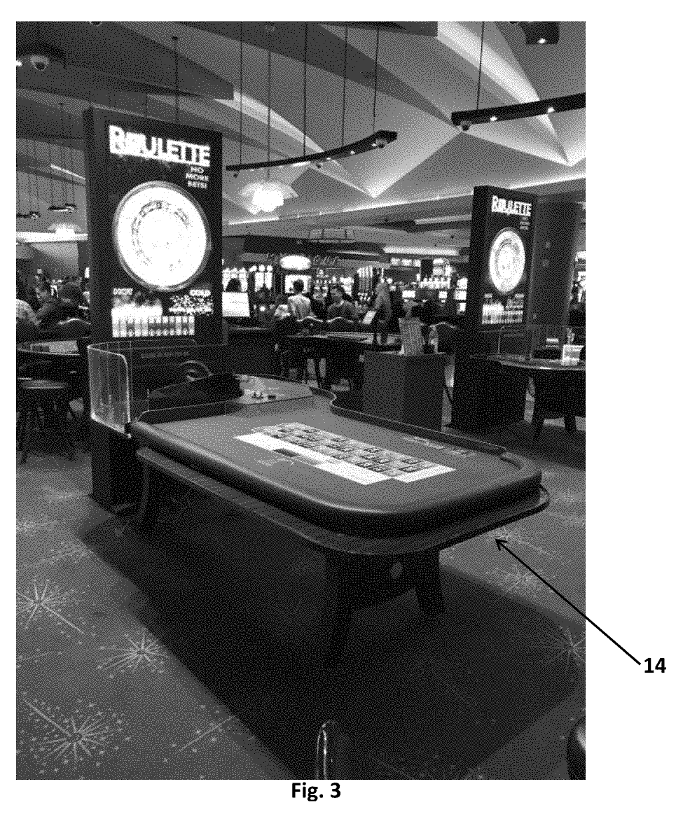

In the play of the game in the cardplay casino game system, as seen in FIG. 3, the main player visual aid displays show a message to place bets when betting is opened in the game after, or as, the cards are shuffled. A bets timer dealer display 58 displays the message for the dealer.

When the dealer announces a “no more bets” message, bets are closed, players are not allowed to place or change bets anymore. If bets are placed virtually, software disables and prevents any bet changes. The dealer can then take a random card from the shuffled card deck, swipes it over the card scanner, and puts it upside down next to the scanner. When the dealer swipes the card over the barcode scanner it scans the barcode on the card or can slide the card over a recognition camera to read results. The system is able to generate a sound and/or graphical alert, to let the dealer and players know that a card has been successfully scanned. After the card is scanned, the card scanner will disable itself to prevent a card from being accidentally scanned multiple times. The dealer does not reveal the card to the players at this point.

After the card is scanned, an animation is able to be shown on the main display and other devices. The game result will be clearly visible, and a scanned card is able to be shown. The dealer's display shows the game result and the card that was scanned. When the result is shown, the dealer can take the scanned card and reveal it to the players to confirm the result. The players have access to the card, through game result mapping. Several prior game results can be checked in the game history.

After the game result is revealed, the dealer, in a manual game or the game software in an automated game, determines the payouts. The system enables the dealer to take another random card from the deck and scan it. Whether another card is to be scanned depends on the game rules and the enabled game options. When all payouts are completed, the system prepares for the next game. All cards are reshuffled, and a new “place your bets” stage is initiated.

In the play of a cardplay casino game, for example, in an embodiment of the cardplay casino game system and method for card roulette, the cards used come from a standard fifty-two card deck. Some games will also use the two jokers that come with the deck. The system uses thirty-eight cards, comprising the ace through nine of each suit, hearts, clubs, diamonds and spades, and the king of hearts and clubs. The backs of the cards contain an approved gaming logo or other design and are designed to eliminate the ability of any person to place concealed markings on them. The color and design of the back of the cards in the deck are uniform and identical. No card shall contain any markings, symbol, or design, other than a logo, that enables a player to identify any value printed on the face of the card.

The dimensions of the cards in play shall be of unvaried size. No cards are to be used that are taped, cut, shaved, marked, defaced, bent, crimped, or deformed. The game is played with one red and one blue deck of cards of the same design. Cards are scanned using a multi sight camera connected to a computer and monitor to display the Roulette Table number associated with the card.

Card roulette is played using a card shuffling device. In performing the card shuffle in the card shuffling machine, the entire deck of cards are removed from the discard rack with the right hand and the cards are placed in front of the rack. The cards are inserted face down into the shuffler with the left hand. The cards are dealt out by the shuiffling device.

Cards are dealt after all buy-ins have been attended to, after the table has been surveyed, after wagers have been placed, and after ante has been collected.

For The deal of the cards, at the conclusion of the previous round of play, the dealer will announce “Place Your Bets” and allow sufficient time for players to place their wagers. The dealer shall announce “No More Bets” and wave off player wagering. The “wave off” is done with the dealer's left hand, going from right to left across the layout. The dealer will activate the shuffling device. The shuffling device will deal out three cards. The dealer will remove three cards from the shuffling and spread them face down on the layout, from left to right. The shuffling device includes a tray, and will then discharge all of the thirty-five remaining cards into the tray. The Dealer will push the middle of the three cards, namely the second card, forward and place the first and third cards in the discard rack.

The Dealer will slide the remaining card face down onto the card reader. The dealer will verify that the card has been scanned successfully and slide the card face down in front of the scanning device. The spin is initiated on a successful scan. The winning number shall be determined based on the card scanned by the camera in the card reader. The dealer will remove the thirty-five cards from the shuffling device tray and place them face down in the discard rack. The dealer will announce the winning number, color and whether it is even or odd, and place a marker over the winning number palm up. The dealer will then expose the scanned card by turning it face up to overhead cameras and then place the card into the discard rack face down with the left hand.

When the marker is on the table, players may not place wagers, collect wagers, or remove any wagers from the table. If the winning number is one through eighteen, the dealer will use the right hand to mark, nineteen through thirty-six, the left hand to mark with the palm up. The dealer will begin collecting the losing wagers, if any, in the same order as payouts are made, Once all losing wagers have been collected, the dealer will pay all winning wagers, Once all wagers have been taken and paid, the dealer will remove the marker from the layout, remove the cards from the discard rack, strip the deck three times and place all cards back into the shuffling device tray.

Further in the play of a cardplay casino game, for example, in an embodiment of the cardplay casino game system and method for the casino game of roulette, the system includes a card-based video simulation of dice rolls made by the dealer-shooter. The system follows roulette game rules and field table simulation regarding virtual dice simulation rolls.

The system in such embodiment includes a roulette table with thirty-six spaces representing the possible outcomes of the dice rolls made by the shooter. The roulette table includes an electronic wheel with 38 slots representing 36 numbers, single zero and double zero, and further includes two betting areas, inside and outside, with corresponding payouts. Inside bets involve betting on a certain straddle or number. Outside bets involve betting on color, odd/even outcomes, and groups of pockets.

The card based roulette simulation game embodiment is operable through dealer card shuffling, by an automated card shuffler or by manual card shuffling, and by dealer card selection. The cards include readable data applied thereto. The system also includes a scanner, such as an optical scanner, for scanning the readable data on the dealer selected cards to generate scanned selected card images. Further, it includes a processing system for translating scanned selected card images into configured roulette dice roll outcomes, and a display monitor, for displaying game play and game outcomes. It also enables player networking, for enabling the placement of bets, the viewing of gameplay, and the displaying of game outcomes and bet results.

Further, in operation of the embodiment of the cardplay casino game system for the casino game of roulette, the dealer runs a deck of 52 cards, with 38 cards used for roulette and 14 cards used for wild hearts, which each represent a spot on the roulette table, through automated or manual shuffling of the cards. The dealer picks a set of three (3) cards that are accessible for dispensing through shuffling, and the dealer selects the middle card to scan into the scanner. The scanner sends the scanned card to the processing system where the image is translated into a correlating number configured as a spot on the roulette wheel. The game will then initiate and display the results on an overhead display monitor.

The system in such embodiment may also incorporate a side bet bonus wager called wild hearts side bet bonus wager. The side bet bonus wager may be placed by the player before the dealer runs a deck of 52 cards.

In another embodiment of the cardplay casino game system for the casino game of craps, the system includes a card-based video simulation of dice rolls made by the dealer-shooter. The system follows craps game rules and field table simulation regarding virtual dice simulation rolls.

The system enables dealer card shuffling, through an automated shuffler or manually, and dealer card selection. The cards include readable data applied thereto. The system also includes a scanner, such as an optical scanner, for scanning the readable data on the dealer selected cards to generate scanned selected card images. Further, it includes a processing system for translating scanned selected card images into configured craps dice roll outcomes, and a display monitor, for displaying game play and game outcomes. It also enables player networking, for enabling the placement of bets, the viewing of gameplay, and the displaying of game outcomes and bet results.

In operation of the embodiment of the cardplay craps casino game system, the dealer runs a deck of 36 cards, which represents the possible outcomes of the dice roll for the craps table, through automated or manual shuffling of the cards. The dealer picks a set of three (3) cards that are accessible for dispensing through shuffling, and the dealer selects the middle card to scan into the scanner. The scanner sends the scanned card to the processing system where the image is translated into a correlating dice roll outcome. The game will then initiate and display the results on an overhead display monitor.

The cardplay craps casino game system in such embodiment may also incorporate a side bet bonus wager. The side bet bonus wager may be placed by the player before a Come Out roll by the player with a Pass Line wager or with a Don't Pass Line wager. The side bet bonus wager relies on the occurrence of three consecutive sevens being rolled, namely a triple sevens bonus wager, beginning on the Come Out roll.

In such embodiment of the system, there is a wager area that is designated for players that wish to place the triple sevens bonus wager. This area will be numbered 1 to 8 for each side of the table. The dealer will book this bet and will place it in the appropriate wagering area.

If the Come Out roll results in a total of 7, the dealer will mark the designated area on the layout in order to track the number of consecutive occurrences of a 7 being rolled. The first 7 rolled will not pay the wager, but will keep the wager active for the next roll. No more bonus wagers will be accepted until a decision is reached on all active bonus wagers. If any number rolls other than a 7, the triple sevens bonus wager will be declared a loss and the dealer will collect the losing wagers from the triple sevens side bet bonus wager areas. Successive Come Out 7s rolls will proceed in the same manner in the system.

In a still further embodiment of the cardplay casino game system, for the casino game of sicbo, the system includes a dealer-assisted electronic table game. The system follows sicbo game rules and field table simulation regarding virtual dice simulation rolls. The system enables dealer card shuffling, through an automated shuffler or manually, and dealer card selection.

The cards include readable data applied thereto. The system also includes a scanner, such as an optical scanner, for scanning the readable data on the dealer selected cards to generate scanned selected card images and which assist the dealer in game play. All game play is conducted by the dealer, including paying all wins and collecting all losing bets. The system also includes a scanner, such as an optical scanner, for scanning dealer selected cards to generate scanned selected card images. Further, it includes a processing system for translating scanned selected card images into configured scibo dice roll outcomes. It also enables player networking, for enabling the placement of bets, the viewing of gameplay, and the displaying of game outcomes and bet results.

The system in such embodiment further includes consists of three individual displays, a top display, player display, and dealer display. The top display acts as digital signage and displays the scibo game as an attract screen. The player display shows a video dice roll as a representation of the three card draw. The dealer display is a touch-screen enabled display to facilitate game play through the various stages of the game.

In operation of the embodiment of the cardplay sicbo casino game system, the dealer runs a deck of 18 cards, which represents the possible outcomes of the dice roll for the sicbo table, through automated or manual shuffling of the cards. The deck of 18 cards to represent three 6-sided dice. The 18 cards are Ace, Two, Three, Four, Five and Six in each set, which represent numbers 1 through 6 respectively. The 18 cards have barcodes which allow the cards to be scanned by the optical scanner and to assist the dealer to conduct game play. All game play is conducted by the dealer, including paying all wins and collecting all losing bets.

The stages of the game include Place Bets, No More Bets, Card Scanning and Dice Roll Display, and Game Results. During the Place Bets stage, the dealer presses a Start Betting button to initiate a countdown sequence that alerts players to place their bets on the table. During the No More Bets stage, the countdown timer either expires or the dealer presses the Stop Betting button to indicate to the players that no more bets will be allowed. During the Card Scanning and Dice Roll Display stage, the dealer scans three of the cards to the optical scanner. During the Game Results stage, the video representation of the dice roll is displayed, and the winning outcomes are highlighted on the sicbo play field on the player display. Once the game results are displayed, the dealer can start the next game at the first Place Bets stage.

The system enables the sicbo game to be customizable for various configurations. The betting time and playing time can be configured to facilitate the speed of game play. Display prompts for Betting Time, Bet Please and No More Bet Please can be enabled or disabled. The language for the display prompts can be configured. The audio can be configured, and the language for audio can be configured. The pay table options can be configured to display various pays based on winning combinations. The game can be configured to start a new game once the previous game outcome is complete, and to automatically transition to the No More Bets stage after the Place Bets stage is complete. Passwords can also be set for configuration. The game history of cards and dice outcomes can be viewed for dealer convenience. Since this is a dealer assisted electronic table game where the dealer is responsible for all game wagers, paying all wins, and collecting all losing bets, the game history does not contain any game play data, and only contains the card and dice outcomes.

While the particular systems and methods as shown and disclosed in detail herein are fully capable of obtaining the objects and providing the advantages previously stated, it is to be understood that it is merely illustrative of the presently preferred embodiments of the invention, and that no limitations are intended to the details of construction or design shown herein.

I claim:

1. A system for enabling the playing of a first game and a second game, including:
an element for randomly generating a first gameplay and for generating the results of the first gameplay responsive to the playing of the first game;
an element for mapping the first game results into the second game;
an element for taking the first game results and generating and visually aiding the first game results into the second game results; and
an element for visually aided displaying of the second game.

2. A system as in claim 1, including an element for taking the first game results and mapping and visually aiding the first game results into the second game results.

3. A system as in claim 1, including an element for enabling for playing of the games by players.

4. A system as in claim 1, which includes first gameplay components for the play of the first game, and second gameplay components for the play of the second game, and the system generates visually-aided gameplay from the first gameplay components to second gameplay components.

5. A system as in claim 1, including an element for enabling obtaining of the first game results.

6. A system as in claim 1, which includes a dealer, and which enables the dealer to supervise the playing of the first game and the second game.

7. A system as in claim 1, which includes a player, and which enables the player to play the first game and the second games

8. A system as in claim 1, which enables the winning of bets by players and the losing of bets by players from the playing of the first game and the playing of the second game.

9. A system as in claim 1, which includes a processing system and a server for enabling gameplay and interconnectable communication.

10. A system as in claim 1, which enables communication between dealer and players.

11. A system as in claim 1, for enabling the playing of a third game, including an element for mapping the first game results into the third game, an element for taking the first game results and generating and visually aiding the first game results into the third game results, and an element for enabling the visually aided displaying of the third game.

12. A system as in claim 2, wherein the visually-aided gameplay includes visually-aided graphical gameplay.

13. A system as in claim 4, wherein the system is adapted to enable the sending of the second game results to the players.

14. A system as in claim 8, which enables the dealer to reconcile winning and losing results of all bets from the players.

15. A system as in claim 9, which enables betting by players interconnected with the dealer.

16. A system as in claim 9, which includes player devices, and the player devices comprise smart inter-connectable devices.

17. A system as in claim 10, which enables player wagering remotely from the dealer table.

18. A system as in claim 16, which enables bi-directional communication between dealer and players.

19. A method of enabling the playing of a first game and a second game, comprising:
randomly generating a first gameplay;
generating the results of the first gameplay responsive to the playing of the first game;
enabling the playing of a second game;
mapping the first game results into the second game;
generating and visually aiding the second game from the first game results; and
enabling the visually aided displaying of the second game.

20. A method as in claim 19, further comprising enabling the taking of the first game results and the mapping and visually aiding of the first game results into the second game results.
